(19) United States
(12) Patent Application Publication
(10) Pub. No.: US 2024/0406713 A1
(43) Pub. Date: Dec. 5, 2024

(54) TERMINAL TARGET PLANE CAPABILITY REPORTING AND OBTAINING METHOD, TERMINAL, AND NETWORK DEVICE

(71) Applicant: VIVO MOBILE COMMUNICATION CO., LTD., Dongguan (CN)

(72) Inventors: Yannan YUAN, Dongguan (CN); Fei QIN, Dongguan (CN)

(73) Assignee: VIVO MOBILE COMMUNICATION CO., LTD., Dongguan (CN)

(21) Appl. No.: 18/800,006

(22) Filed: Aug. 10, 2024

Related U.S. Application Data
(63) Continuation of application No. PCT/CN2023/074985, filed on Feb. 8, 2023.

(30) Foreign Application Priority Data
Feb. 11, 2022 (CN) 202210130263.9

(51) Int. Cl. H04W 8/22; H04W 28/02; H04W 60/04

(52) U.S. Cl. CPC H04W 8/22; H04W 28/0257; H04W 60/04

(57) ABSTRACT

A terminal target plane capability reporting and obtaining method, a terminal, and a network device, are provided. The terminal target plane capability reporting method includes: reporting target plane capability information of the terminal, wherein a target plane is a protocol function plane configured to support at least one of data collection, data distribution, data security, data privacy, data analysis, or data preprocessing.

### CROSS-REFERENCE TO RELATED APPLICATIONS

This application is a continuation of International Application No. PCT/CN2023/074985, filed on Feb. 8, 2023, which claims priority to Chinese Patent Application No. 202210130263.9, filed Feb. 11, 2022. The entire contents of each of the above-identified applications are expressly incorporated herein by reference.

### TECHNICAL FIELD

This application pertains to the field of wireless communication technologies, and specifically, to a terminal target plane capability reporting and obtaining method, a terminal, and a network device.

### BACKGROUND

An existing network does not support data collection control for end-to-end network functions, for example, data collection control between a User Equipment (UE) and a Core Network (CN), and data collection control between the user equipment and a Radio Access Network (RAN), making it difficult to implement some application services with high quality of service assurance, for example, application services such as sensing and computing in a 6th Generation (6G) communication system network.

Therefore, a problem of how to support the data collection and use for end-to-end network functions needs to be resolved.

### SUMMARY

Embodiments of this application provide a terminal target plane capability reporting and obtaining method, a terminal, and a network device.

According to a first aspect, a terminal target plane capability reporting method is provided, including:

A terminal reports target plane capability information of the terminal, where a target plane is a protocol function plane configured to support at least one of data collection, data distribution, data security, data privacy, data analysis, or data preprocessing.

According to a second aspect, a terminal target plane capability obtaining method is provided, including:

A network function receives target plane capability information of a terminal, where a target plane is a protocol function plane configured to support at least one of data collection, data distribution, data security, data privacy, data analysis, or data preprocessing.

According to a third aspect, a terminal target plane capability reporting apparatus is provided, including:

a first reporting module, configured to report target plane capability information of a terminal, where a target plane is a protocol function plane configured to support at least one of data collection, data distribution, data security, data privacy, data analysis, or data preprocessing.

According to a fourth aspect, a terminal target plane capability obtaining apparatus is provided, including:
a first receiving module, configured to receive target plane capability information of a terminal, where a target plane is a protocol function plane configured to support at least one of data collection, data distribution, data security, data privacy, data analysis, or data preprocessing.

According to a fifth aspect, a terminal is provided. The terminal includes a processor and a memory. The memory stores a program or instructions executable on the processor, and the program or the instructions, when executed by the processor, implement steps of the method according to the first aspect.

According to a sixth aspect, a terminal is provided, including a processor and a communication interface. The communication interface is configured to report target plane capability information of the terminal, and a target plane is a protocol function plane configured to support at least one of data collection, data distribution, data security, data privacy, data analysis, or data preprocessing.

According to a seventh aspect, a network function is provided. The network function includes a processor and a memory. The memory stores a program or instructions executable on the processor, and the program or the instructions, when executed by the processor, implement steps of the method according to the second aspect.

According to an eighth aspect, a network function is provided, including a processor and a communication interface. The communication interface is configured to receive target plane capability information of a terminal, and a target plane is a protocol function plane configured to support at least one of data collection, data distribution, data security, data privacy, data analysis, or data preprocessing.

According to a ninth aspect, a communication system is provided, including: a terminal and a network function, where the terminal is configured to perform steps of the method according to the first aspect, and the network function is configured to perform steps of the method according to the second aspect.

According to a tenth aspect, a readable storage medium is provided. The readable storage medium stores a program or instructions, and the program or the instructions, when executed by a processor, implement steps of the method according to the first aspect, or implement steps of the method according to the second aspect.

According to an eleventh aspect, a chip is provided. The chip includes a processor and a communication interface. The communication interface is coupled to the processor, and the processor is configured to run a program or instructions, to implement the method according to the first aspect, or implement the method according to the second aspect.

According to a twelfth aspect, a computer program/program product is provided. The computer program/program product is stored in a storage medium. The computer program/program product is executed by at least one processor, to implement steps of the method according to the first aspect or the second aspect.

In embodiments of this application, a terminal reports target plane capability information to a network function, where a target plane is a protocol function plane configured to support at least one of data collection, data distribution, data security, data privacy, data analysis, or data preprocessing.

### BRIEF DESCRIPTION OF THE DRAWINGS

FIG. 1 is a block diagram of a wireless communication system to which an embodiment of this application is applicable;

FIG. 2 is a schematic diagram of a structure of a data collection system using data collection coordination according to an embodiment of this application;

FIG. 3 is a block diagram of an open network data analytics system using data collection coordination according to an embodiment of this application;

FIG. 4 is a schematic diagram of an architecture of an O-RAN according to an embodiment of this application;

FIG. 5 is a schematic diagram of UE capability transmission according to an embodiment of this application;

FIG. 6 is a flowchart of a terminal target plane function reporting method according to an embodiment of this application;

FIG. 7 is a flowchart of a terminal target plane function obtaining method according to an embodiment of this application;

FIG. 8 is a flowchart of a terminal target plane function reporting method according to Embodiment 1 of this application;

FIG. 9 is a flowchart of a terminal target plane function reporting method according to Embodiment 2 of this application;

FIG. 10 is a flowchart of a terminal target plane function reporting method according to Embodiment 3 of this application;

FIG. 11 is a flowchart of a terminal target plane function reporting method according to Embodiment 4 of this application;

FIG. 12 is a block diagram of a terminal target plane function reporting apparatus according to an embodiment of this application;

FIG. 13 is a block diagram of a terminal target plane function obtaining apparatus according to an embodiment of this application;

FIG. 14 is a schematic diagram of a structure of a communication device according to an embodiment of this application;

FIG. 15 is a block diagram of a terminal according to an embodiment of this application;

FIG. 16 is a block diagram 1 of a network device according to an embodiment of this application; and

FIG. 17 is a block diagram 2 of a network device according to an embodiment of this application.

### DETAILED DESCRIPTION

The embodiments of this application are described in the following with reference to the accompanying drawings in embodiments of this application. The described embodiments are a part rather than all of embodiments of this application. All other embodiments obtained by a person of ordinary skill in the art based on embodiments of this application fall within the protection scope of this application.

The terms “first,” “second,” and the like in the specification and claims of this application are used to distinguish similar objects, but are not used to describe a specific sequence or order. It should be understood that the terms used in this way are exchangeable in an appropriate case, so that embodiments of this application can be implemented in an order other than those orders shown or described herein. In addition, objects distinguished by using “first” and “second” are usually of a type, and a quantity of objects is not limited. For example, there may be one or more first objects. In addition, “and/or” used in the specification and claims represents at least one of connected objects, and the character “/” usually represents an “or” relationship between associated objects.

It should be noted that technologies described in embodiments of this application are not limited to a Long Term Evolution (LTE)/LTE-Advanced (LTE-A) system, and may further be applied to other wireless communication systems, including Code Division Multiple Access (CDMA), Time Division Multiple Access (TDMA), Frequency Division Multiple Access (FDMA), Orthogonal Frequency Division Multiple Access (OFDMA), Single-Carrier-Frequency Division Multiple Access (SC-FDMA), and other systems. The terms “system” and “network” in embodiments of this application are usually interchangeable, and the described technologies may be not only applied to the systems and radio technologies described above, but also applied to other systems and radio technologies. The following describes a New Radio (NR) system for illustrative purposes, and NR terms are used in most of the following descriptions. However, these techniques may also be applied to an application other than NR system applications, for example, a 6th Generation (6G) communication system.

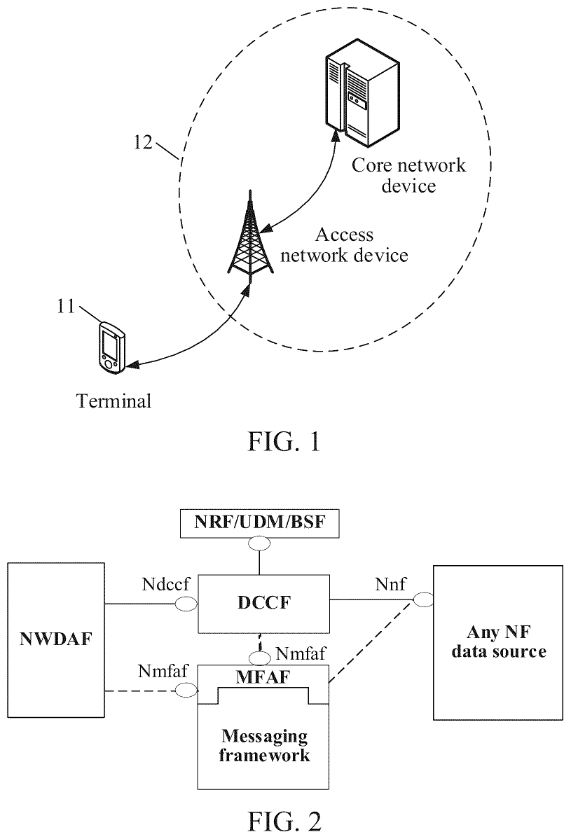

FIG. 1 is a block diagram of a wireless communication system to which an embodiment of this application is applicable. The wireless communication system includes a terminal 11 and a network-side device 12. The terminal 11 may be a terminal-side device, for example, a mobile phone, a tablet personal computer, a laptop computer, or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a Vehicle User Equipment (VUE), a Pedestrian User Equipment (PUE), a smart home (a home device with a wireless communication function, such as a refrigerator, a television, a washing machine, or furniture), a game machine, a personal computer (PC), a teller machine, or a self-service machine. The wearable device includes a smart watch, a smart band, a smart headphone, smart glasses, smart jewelry (a smart bangle, a smart bracelet, a smart ring, a smart necklace, a smart anklet, a smart anklet, and the like), a smart wristband, smart clothing, and the like. It should be noted that a specific type of the terminal 11 is not limited in embodiments of this application.

The network-side device 12 may include an access network device or a core network device, where the access network device may also be referred to as a radio access network device, a Radio Access Network (RAN), a radio access network function, or a radio access network unit. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the field. As long as the same technical effect is achieved, the base station is not limited to a specific technical vocabulary. It should be noted that in embodiments of this application, a base station in the NR system is only used as an example for description, and a specific type of the base station is not limited.

The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that in embodiments of this application, a core network device in the NR system is only used as an example for description, and a specific type of the core network device is not limited.

The following first describes communication terms related to this application.

### (1) 5th Generation (5G) Communication System Network Data Analytics Service

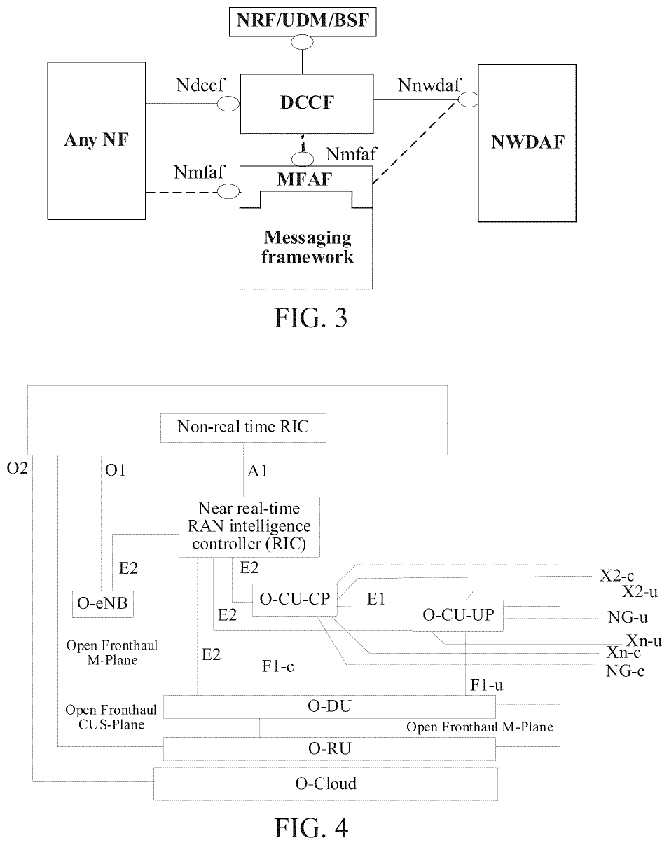

Refer to FIG. 2 and FIG. 3. A NetWork Data Analytics Function (NWDAF) is one of 5G Core (5GC) network control plane network functions, and interacts with different entities based on different purposes:
collecting data based on an event subscription provided by an AMF, an SMF, a PCF entity, a UDM entity, an AF (directly or through an NEF), or an Operation Administration Maintenance (OAM);
performing analysis and data collection by using a Data Collection Coordination Function (DCCF);
retrieving information from a data repository (for example, retrieving a User Desired Requirement (UDR) in user-related information by using the UDM);
storing and retrieving information by using an Analytics Data Repository Function (ADRF;
performing analysis and data collection by using a Messaging Framework Adaptor Function (MFAF);
retrieving information about a Network Function (NF) entity (for example, retrieving information related to NFs from an NF Repository Function (NRF));
providing analysis to a consumer based on a requirement; and
providing a large amount of data to the consumer.

Although the 5G core network control plane NWDAF supports data analysis based on core network Control Plane (CP) data and supports analysis and data collection by using the DCCF, a function of the NWDAF is only limited to the subscription event provided by the 5G core network control plane network function, and the NWDAF does not support collecting data of a core network user plane, a radio access network, and a UE. In addition, an existing network does not support real-time data subscription and service. Interface performance and a function design offer no support. In addition, because a data service related function is not standardized, a network element device does not consider this part of overheads, and consequently, reporting of a large amount of real-time data affects network performance.

### (2) 5G O-RAN Network Architecture

As shown in FIG. 4, in comparison with an existing 5G radio access network architecture and function, an Open Radio Access Network (O-RAN) proposes a RAN Intelligence Controller (RIC), including a non-real time radio intelligence controller and a near real-time radio intelligence controller. For a management plane, the non-real time radio intelligence controller is added to a service management and orchestration system, and interacts with the near real-time radio intelligence controller through an AI interface to transmit a policy, auxiliary information, and the like. For a network function, the near real-time radio intelligence controller is introduced, and is connected to a base station (for example, a gNB or an eNB) or a base station subsystem (a part of baseband functions, such as a Centralized Unit-Control Plane (CU-CP) or a Distributed Unit (DU)) through an E2 interface, to collect data, and transmit a policy, control information, and the like.

The radio intelligence controller of the O-RAN is an intelligent function external to a 3GPP 5G protocol standard. Although defined as a network function in an O-RAN standard, the near real-time radio intelligence controller may be connected to a plurality of gNBs/gNBs-CUs/gNBs-CU-CPs/eNBs, and is transparent to a CN and a UE. Therefore, a logical connection relationship of the near real-time radio intelligence controller is more similar to that of a network management function. In addition, the near real-time radio intelligence controller currently focuses on data analysis applications on a network side, and cannot support providing a data collection and analysis service to an external network function. Because the near real-time radio intelligence controller belongs to a wireless side, the near real-time radio intelligence controller cannot support UE identifier (Identifier, ID) association of persistent data for UE-level data. In addition, resources of a wireless-side network device are scarce, and therefore, an existing base station device cannot support reporting a large amount of near real-time or real-time data when traffic load is high.

### (3) 5G UE Capability Definition and Reporting Solution

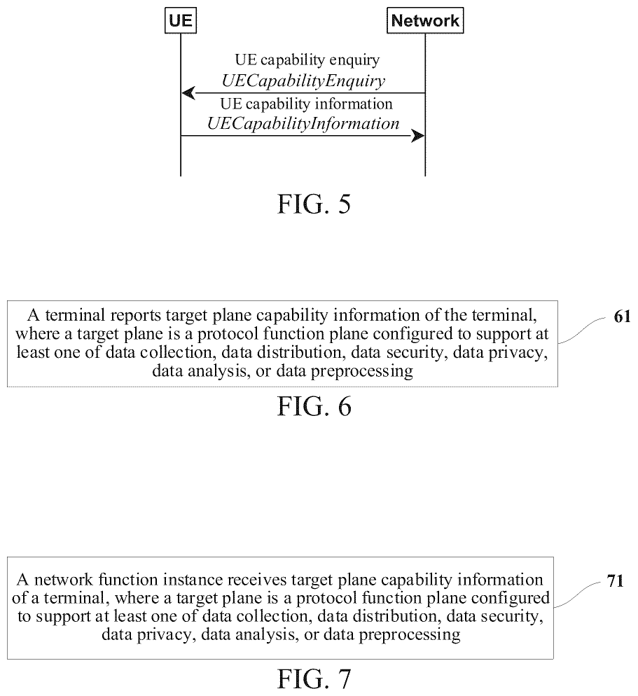

Based on a definition of a UE feature in 38.822, a part of mandatory features does not need UE capability signaling interaction. If a network needs to learn other UE capability information based on the mandatory feature, based on a definition in 38.331, as shown in FIG. 5, the network may transmit a UE capability request (UECapabilityEnquiry) to a UE, and the UE reports corresponding UE capability information (UECapabilitylnformation) based on a request message. A UE capability is defined in 38.306. Currently, the UE capability mainly accesses various protocol layers (Service Data Adaption Protocol (SDAP)/Packet Data Convergence Protocol (PDCP)/Radio Link Control (RLC)/Media Access Control (MAC)/Physical Layer (PHY)) in a wireless manner.

In the definitions of the UE feature and the UE capability in an existing protocol and the UE capability reporting solution both, content related to a target plane is not considered, and needs to be considered after the target plane is introduced.

The following describes in detail a terminal target plane capability reporting and obtaining method, a terminal, and a network device provided in embodiments of this application with reference to the accompanying drawings according to some embodiments and application scenarios of the embodiments.

Refer to FIG. 6. An embodiment of this application provides a terminal target plane capability reporting method, and the method includes the following steps.

Step 61: A terminal reports target plane capability information of the terminal, where a target plane is a protocol function plane configured to support at least one of data collection, data distribution, data security, data privacy, data analysis, or data preprocessing.

In some implementations of this application, a target plane capability includes a capability of the terminal to perform interaction of control information and/or data information of the target plane. The control information of the target plane includes configuration information of one or more of functions such as connection establishment, the data collection, the data distribution, the data security, the data privacy, the data analysis, and the data preprocessing of the target plane, and the data information of the target plane includes data required for performing the functions.

In this application, the target plane is used as a protocol function plane newly added based on a CP and a UP that is configured to support at least one of the data collection, the data distribution, the data security, the data privacy, the data analysis, or the data preprocessing. The target plane may also be referred to as a data plane.

In some implementations of this application, the target plane may be used for network optimization, to improve network efficiency and user experience; may also be configured to implement newly added 6G application services (for example, sensing and computing) with high Quality of Service (QoS) assurance; and may also provide a data anchor for a user, to meet requirements of the user on data monetization and data security. For each user (corresponding to one or more user equipment) or each user equipment (UE), considering a user selection intention and a UE software and hardware design function, a UE target plane feature and a UE capability definition should meet a plurality of cases and combinations of the user and a UE software and hardware design.

In some implementations of this application, the terminal reports the target plane capability information to a network function, where the target plane is the protocol function plane configured to support at least one of the data collection, the data distribution, the data security, the data privacy, the data analysis, or the data preprocessing, to implement data collection and use for end-to-end network functions.

In some implementations of this application, the target plane capability information includes at least one of the following:
(1) information indicating whether the terminal supports the target plane;

When the terminal is designed, a UE target plane function may be supported on demand based on a target user and/or software and hardware planning. When the target plane is not supported, corresponding overheads on a UE side is minimal.

In addition, whether the target plane capability is supported may be dynamically updated.
(2) information indicating that the target plane capability is a capability of a single terminal or a terminal group, where the terminal group includes at least two terminals;

The foregoing case may occur in a terminal group formed by a plurality of terminals of a user, where one or more types of terminals such as a mobile phone, a wristband, and glasses may be included. The foregoing case may also occur in a terminal group formed by a plurality of terminals connected through a sidelink. The foregoing case may also occur in a terminal group formed by a plurality of terminals configured in a network, and the terminals in the terminal group interact through a mobile access network base station and/or a core network.

In some implementations of this application, the terminal group includes at least one 3GPP terminal, and may further include one or more non-3GPP terminals. In 3GPP communication, the 3GPP terminal is usually defined as a terminal, such as a UE (a mobile phone or a Customer Premise Equipment (CPE)) having a Subscriber Identify Module (SIM), an Embedded-SIM (eSIM), or an MUSIM, and the non-3GPP terminal is, for example, a wristband, a watch, or another health monitoring device connected to the UE through Wi-Fi or Bluetooth.

In some implementations of this application, the capability of the terminal group may be reported by a 3GPP terminal in the terminal group.
(3) information indicating that the target plane capability is a static capability or a dynamic capability;

In some implementations of this application, the static capability indicates that the target plane capability is static and is not dynamically adjusted. For example, the static capability may be a maximum target plane capability or a minimum target plane capability that can be supported by the UE. The capability may be set by the UE based on a hardware design of the UE and/or resource allocation. The dynamic capability indicates that the target plane capability is dynamic and may be dynamically adjusted. For example, the dynamic capability is dynamically adjusted and updated based on communication load of the UE. When the target plane capability is the static capability, the UE reports or enquires the network for corresponding target plane capability information, and the corresponding target plane capability information is unchanged. When the target plane capability includes the static capability and the dynamic capability, the maximum or minimum target plane capability is usually used as an upper limit or a lower limit of the target plane capability, and a current capability status of the target plane capability is dynamically decided based on an impact factor.
(4) a supported target plane capability reporting manner;

In some implementations of this application, the target plane capability reporting manner may include at least one of the following: active reporting upon a capability update, reporting based on meeting a network configuration change condition, and network enquiry reporting.
(5) information indicating whether a target plane capability reporting manner configured by a network side is supported;

In some implementations of this application, if the target plane capability reporting manner configured by the network side is not supported, update is performed based on a supported default target plane capability reporting manner; and if the target plane capability reporting manner configured by the network side is supported, update is performed based on the target plane capability reporting manner configured by the network side.
(6) a supported target plane data reporting mode;

In some implementations of this application, the target plane data reporting mode includes: subscription reporting, default data collection reporting, and/or the like. The subscription reporting means determining, through interaction between the network function and the UE, data that needs to be reported, a measurement or reporting condition, and/or the like, and performing data reporting on this basis. The default data collection reporting means that by using a pre-agreed data collection item between the network function and the UE, the UE reports agreed data by default, or the UE reports agreed data based on turning on or off of a target plane of the UE and/or enabling or disabling data collection by the network side.
(7) a data type supported by the target plane;

In some implementations of this application, the data type supported by the target plane includes at least one of the following: communication data, sensing data, computing data, Artificial Intelligence (AI) data, user subscription data, network operation data, and digital twin data.
(8) a supported transmission direction of the target plane;

In some implementations of this application, the supported transmission direction of the target plane includes an uplink direction and/or a downlink direction. Usually, a control information interaction capability of the target plane includes both uplink and downlink capabilities. For a data exchange capability of the target plane, if uplink is supported, it means that the UE supports data reporting of the target plane; and if downlink is supported, it means that the UE supports data receiving of the target plane.

For example, communication-oriented data reporting may be providing communication measurement data required for communication quality of service optimization, sensing-oriented data reporting may be providing a sensing measurement quantity needed for sensing, computing-oriented or AI-oriented data oriented reporting may be providing computing input and/or output data required for computing, communication-oriented data receiving may be receiving data information needed for local communication decision of the UE, sensing-oriented data receiving may be receiving a sensing measurement quantity or a sensing result needed for local sensing or decision, and computing-oriented data receiving may be receiving input and/or output data for computing.
(9) a supported maximum data uplink rate of the target plane;

The supported maximum data uplink rate of the target plane may also be expressed as a supported maximum data collection rate or a supported maximum reporting rate. To avoid an excessively large continuous data range of the item and representation difficulty, different rate ranges may be defined as different levels of a rate. In this case, only level information needs to be provided for the item, to improve representation efficiency.
(10) a supported maximum data downlink rate of the target plane;

The item may also be expressed as a supported maximum data use rate, a supported maximum data distribution rate, or a supported maximum receiving rate. Similarly, different rate ranges may also be defined as different levels of a rate. In this case, only level information needs to be provided, to improve representation efficiency.
(11) a total buffer size of the target plane;

The item may be a total buffer size of all protocol layers, or may be total buffer sizes of layers, for example, a total buffer size of a layer-2 and/or a total buffer size of a layer-3.
(12) a supported target plane function;

The target plane function may include at least one of the data collection, the data distribution, the data security, the data privacy, the data analysis, or the data preprocessing.
(13) a supported maximum quantity of data collection items;

Because the data collection needs corresponding support of a hardware resource and software processing, the item indicates a maximum quantity of data collection items that can be supported simultaneously. For example, a maximum of two data collection items: Reference Signal Received Power (RSRP) and Reference Signal Received Quality (RSRQ) are supported simultaneously. The item may be a maximum quantity of data collection items that can be supported for all data. When data is classified or defined in levels, the item may alternatively be represented as a supported maximum quantity of data collection items for data of a specific type or a specific level.
(14) a supported ID sequence number size;

For example, during data collection configuration, a data collection subscription ID is usually sent to the UE, and a length of an ID sequence number may be represented by a quantity of bits. When the UE needs to use data provided by the target plane, there is also a corresponding data receiving subscription ID.
(15) a supported minimum time granularity of data collection;

The item indicates a minimum time granularity in which the UE can collect data. For
example, for the RSRP, a minimum time granularity is a Transmission Time Interval (TTI).
(16) a supported minimum time granularity of data reporting;

The item indicates a shortest reporting interval that the UE can support after data required by the target plane is collected. The base station may configure the data collection of the UE and schedule a resource of the target plane based on the capability information.
(17) a supported maximum length of a single target plane packet;

The packet may be oriented to the data reporting and/or the data receiving.
(18) information indicating whether the terminal supports data collection and reporting in a connected state;
(19) information indicating whether the terminal supports data collection and reporting in an idle state and/or an inactive state; or
(20) information indicating whether the terminal supports continuity of a target plane across states.

The item indicates corresponding target plane configuration and control information when the UE switches from one state to another state, and whether data exchange of the target plane has continuity.

In some embodiments of this application, that a terminal reports target plane capability information of the terminal includes: The terminal reports the target plane capability information of the terminal to a core network device.

In some implementations of this application, the core network device may be a first target plane network function instance, and the first target plane network function instance implements a network function of the core network device for supporting at least one of the data collection, the data distribution, the data security, the data privacy, the data analysis, or the data preprocessing; The first target plane network function instance may also be referred to as a core network target plane network function instance.

In some implementations of this application, a network function instance is a 3GPP processing module or a 3GPP-defined processing module used in the network, and has defined functional behavior and an interface defined by 3GPP. The network function may be implemented as a network element on dedicated hardware, a software instance run on dedicated hardware, or a virtualization function instantiated on an appropriate platform (for example, a cloud infrastructure). The network function instance is implemented by software and/or hardware that can run the network function.

In some implementations of this application, if there is a direct connection between the terminal and the first target plane network function instance, the terminal may directly report the target plane capability information of the terminal to the first target plane network function instance.

In some implementations of this application, the core network device may be another core network device, for example, an AMF.

In some implementations of this application, if there is no direct connection between the terminal and the first target plane network function instance, the terminal may report the target plane capability information of the terminal to another core network device, for example, an AMF, and the first target plane network function instance obtains the target plane capability information of the terminal from the another core network device.

Furthermore, that the terminal reports the target plane capability information of the terminal to a core network device includes: The terminal transmits a registration request message to the core network device when accessing a network, where the registration request message carries the target plane capability information of the terminal. In some implementations of this application, the core network device may be an AMF, in other words, the terminal reports the target plane capability information of the terminal to the AMF, and the first target plane network function instance obtains the target plane capability information of the terminal from the AMF.

In some embodiments, that the terminal reports the target plane capability information of the terminal to a core network device includes: The terminal reports all target plane capability information of the terminal to the core network device.

In some embodiments, that the terminal reports the target plane capability information of the terminal to a core network device includes: The terminal reports a part of target plane capability information of the terminal to the core network device. In this manner, a length of the reported information can be reduced. For example, when reporting is performed by using the registration request message, an information length occupied by the target plane capability information of the terminal in the registration request message can be reduced. In some implementations, the part of target plane capability information is necessary information needed by the first target plane network function instance, and can support the first target plane network function instance in deciding whether more target plane information is needed. Therefore, the part may also be referred to as basic information or mandatory capability information. For example, the part of terminal target plane capability information may indicate whether the terminal supports the target plane.

In some embodiments, that the terminal reports the target plane capability information of the terminal to a core network device includes:

The terminal receives target plane capability enquiry information transmitted by a first target plane network function instance, where the enquiry information indicates target plane capability information that needs to be enquired, and the first target plane network function instance implements a network function of the core network device for supporting at least one of the data collection, the data distribution, the data security, the data privacy, the data analysis, or the data preprocessing. The first target plane network function instance may also be referred to as a core network target plane network function instance.

The terminal reports the target plane capability information to the first target plane network function instance based on the target plane capability information that needs to be enquired.

In other words, the target plane capability information of the terminal is enquired on demand.

In some implementations of this application, if there is a direct connection between the terminal and the first target plane network function instance, the first target plane network function instance may directly transmit the target plane capability enquiry information to the terminal; and if there is no direct connection between the terminal and the first target plane network function instance, the first target plane network function instance transmits the target plane capability enquiry information to the terminal through another core network device, for example, an AMF. In addition, the terminal also needs to report the target plane capability information to the first target plane network function instance through the another core network device.

In some embodiments of this application, that a terminal reports target plane capability information of the terminal includes: The terminal reports the target plane capability information of the terminal to a radio access network device.

In some implementations of this application, the radio access network device may be a second target plane network function instance, and the second target plane network function instance implements a network function of the radio access network device for supporting at least one of the data collection, the data distribution, the data security, the data privacy, the data analysis, or the data preprocessing; The second target plane network function instance may also be referred to as a radio access network target plane network function instance.

In some implementations of this application, if there is a direct connection between the terminal and the second target plane network function instance, the terminal may directly report the target plane capability information of the terminal to the second target plane network function instance.

In some implementations of this application, the radio access network device may be another radio access network device, for example, an RRC function.

In some implementations of this application, if there is no direct connection between the terminal and the second target plane network function instance, the terminal may report the target plane capability information of the terminal to another radio access network device, for example, an RRC function, and the second target plane network function instance obtains the target plane capability information of the terminal from the another radio access network device.

In some embodiments, before the terminal reports the target plane capability information of the terminal to a radio access network device, the method further includes: The terminal receives target plane capability enquiry information transmitted by a second target plane network function instance, where the enquiry information indicates target plane capability information that needs to be enquired, and the second target plane network function instance implements a network function of the radio access network device for supporting at least one of the data collection, the data distribution, the data security, the data privacy, the data analysis, or the data preprocessing. The second target plane network function instance may also be referred to as a radio access network target plane network function instance.

That the terminal reports the target plane capability information of the terminal to a radio access network device includes: The terminal reports the target plane capability information to the second target plane network function instance based on the target plane capability information that needs to be enquired.

In other words, the target plane capability information of the terminal is enquired on demand.

In some implementations of this application, if there is a direct connection between the terminal and the second target plane network function instance, the second target plane network function instance may directly transmit the target plane capability enquiry information to the terminal; and if there is no direct connection between the terminal and the second target plane network function instance, the second target plane network function instance transmits the target plane capability enquiry information to the terminal through another radio access network device, for example, an RRC function. In addition, the terminal also needs to report the target plane capability information to the second target plane network function instance through the another radio access network device.

In some implementations of this application, the target plane capability enquiry information is carried in a terminal capability enquiry message.

In some implementations of this application, that a terminal reports target plane capability information of the terminal includes: The terminal reports the target plane capability information of the terminal if a target plane capability update condition is met, where the target plane capability update condition includes at least one of the following:
(1) A level of a target plane capability of the terminal changes.
(2) A parameter and/or a value range of the target plane capability of the terminal that is configured by a network side meets a preset condition.
(3) A value range of a parameter associated with the target plane capability of the terminal changes.

The parameter associated with the target plane capability of the terminal may be a parameter of a user plane and/or a control plane of the terminal.

In some implementations of this application, that the terminal reports the target plane capability information of the terminal if a target plane capability update condition is met includes at least one of the following:

The terminal reports the target plane capability information of the terminal if the target plane capability update condition is met.

The terminal reports the target plane capability information of the terminal if the target plane capability update condition is met and target plane capability enquiry information transmitted by the network side is received.

The terminal reports the parameter associated with the target plane capability of the terminal if the target plane capability update condition is met.

In some implementations of this application, that a terminal reports target plane capability information of the terminal includes:

The terminal reports a target plane static capability of the terminal.

The terminal receives a target plane capability reporting manner configuration and/or a target plane capability update condition transmitted by a network side.

The terminal reports a target plane dynamic capability of the terminal based on the target plane capability reporting manner configuration and/or the target plane capability update condition.

In some implementations of this application, the target plane capability information includes: information indicating that a target plane capability is a capability of a terminal group.

In some implementations of this application, that a terminal reports target plane capability information of the terminal includes: The terminal reports the target plane capability information of the terminal if a target plane capability update condition is met, where the target plane capability update condition includes at least one of the following:

A level of a target plane capability of a terminal in the terminal group changes.

A parameter and/or a value range of the target plane capability of the terminal in the terminal group that is configured by a network side meets a preset condition.

A value range of a parameter associated with the target plane capability of the terminal in the terminal group changes.

The terminal in the terminal group changes.

In some implementations of this application, the target plane capability reported by the terminal may be a capability of the terminal group, and capability parameters do not indicate to which terminal of the terminal group a specific capability parameter belongs. This case is applicable to a terminal group formed by a plurality of terminals of a user. The network does not need to learn capabilities of the terminals. The solution is simple. In addition, privacy of the user and cooperation in the terminal group are improved. In another option, the capability of the terminal group may be reported by using terminals as indexes. In this reporting manner, the network side may learn to which terminal each capability parameter belongs. In other words, the target plane capability information includes: an identifier of each terminal in the terminal group, and the identifier of the terminal is associated with the target plane capability information belonging to the terminal.

Refer to FIG. 7. An embodiment of this application provides a terminal target plane capability obtaining method, and the method includes the following steps.

Step 71: A network function instance receives target plane capability information of a terminal, where a target plane is a protocol function plane configured to support at least one of data collection, data distribution, data security, data privacy, data analysis, or data preprocessing.

In some implementations of this application, the network function instance obtains the target plane capability information, where the target plane is the protocol function plane configured to support at least one of the data collection, the data distribution, the data security, the data privacy, the data analysis, or the data preprocessing, to implement data collection and use for end-to-end network functions.

In some implementations, the target plane capability information includes at least one of the following:
information indicating whether the terminal supports the target plane;
information indicating that a target plane capability is a capability of a single terminal or a terminal group, where the terminal group includes at least two terminals;
information indicating that the target plane capability is a static capability or a dynamic capability;
a supported target plane capability reporting manner;
information indicating whether a target plane capability reporting manner configured by a network side is supported;
a supported target plane data reporting mode;
a data type supported by the target plane;
a supported transmission direction of the target plane;
a supported maximum data uplink rate of the target plane;
a supported maximum data downlink rate of the target plane;
a total buffer size of the target plane;
a supported target plane function;
a supported maximum quantity of data collection items;
a supported ID sequence number size;
a supported minimum time granularity of data collection;
a supported minimum time granularity of data reporting;
a supported maximum length of a single target plane packet;
information indicating whether the terminal supports data collection and reporting in a connected state;
information indicating whether the terminal supports data collection and reporting in an idle state and/or an inactive state; or
information indicating whether the terminal supports continuity of a target plane across states.

In some implementations, the network function instance is a core network function instance (namely, the first target plane network function instance in the foregoing embodiment) or a radio access network function instance (namely, the second target plane network function instance in the foregoing embodiment).

If there is a direct connection between the network function instance and the terminal, the network function instance may directly receive the target plane capability information of the terminal reported by the terminal. If there is no direct connection between the network function instance and the terminal, the network function instance may directly obtain the target plane capability information of the terminal from another network function, for example, an AMF.

In some implementations, the network function instance is the core network function instance, and target plane capability information received by the core network function instance is a part of target plane capability information of the terminal. After a core network function instance receives target plane capability information of a terminal, the method further includes:

The core network function instance transmits target plane capability enquiry information, where the enquiry information indicates target plane capability information that needs to be enquired.

The core network function instance receives the target plane capability information reported by the terminal based on the target plane capability information that needs to be enquired.

In some implementations, the network function instance is the radio access network function instance, and before a radio access network function instance receives target plane capability information of a terminal, the method further includes:

The radio access network function instance transmits target plane capability enquiry information, where the enquiry information indicates target plane capability information that needs to be enquired.

In some implementations, that a network function instance receives target plane capability information of a terminal includes:

The network function instance receives a target plane static capability of the terminal.

The network function instance transmits a target plane capability reporting manner configuration and/or a target plane capability update condition based on the target plane static capability of the terminal.

The network function instance receives a target plane dynamic capability reported by the terminal based on the target plane capability reporting manner configuration and/or the target plane capability update condition.

In the foregoing embodiment, if there is a direct connection between the network function instance and the terminal, the network function instance may directly perform information interaction with the terminal; and if there is no direct connection between the network function instance and the terminal, the network function instance needs to perform information interaction with the terminal through another network function such as an AMF.

The following describes the foregoing methods of this application by using examples in combination with specific application scenarios.

Embodiment 1 of this application: a full reporting solution for a target plane capability of a terminal based on a core network procedure

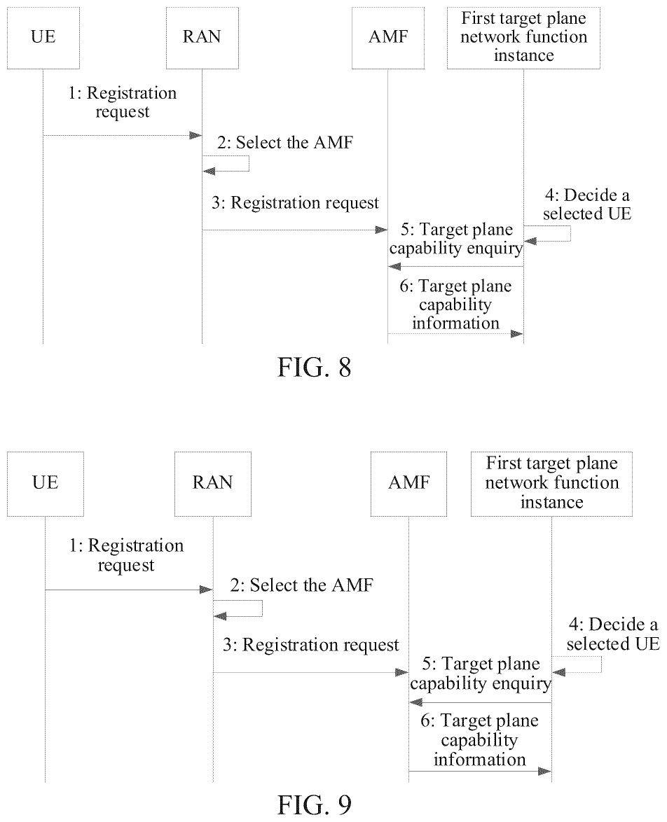

This embodiment of this application provides the terminal target plane capability reporting solution based on the core network procedure. As shown in FIG. 8, a first target plane network function instance is a network function of a core network for supporting any one or more of data collection, data distribution, data security, data privacy, data analysis, or data preprocessing. In this example, the target plane capability is a non-access stratum target plane capability, and may also be referred to as a name such as a capability of a core network data layer. Related steps are as follows:

Steps 1 to 3: When accessing a network, a UE transmits a registration request message to an Access and Mobility Management Function (AMF) by using the access network, and the registration request message carries target plane capability information of the UE.

Step 4: The first target plane network function instance decides a selected UE based on an external data request and/or an internal function.

Step 5: The first target plane network function instance transmits target plane capability enquiry information to the AMF, to request a target plane capability of the selected UE.

Step 6: The AMF transmits target plane capability information of the selected UE to the first target plane network function instance.

Embodiment 2 of this application: a necessary UE target plane capability reporting and enquiring on demand solution based on a core network procedure

This embodiment of this application provides the UE target plane capability reporting solution based on the core network procedure. As shown in FIG. 9, a first target plane network function instance is a network function of a core network for supporting any one or more of data collection, data distribution, data security, data privacy, data analysis, or data preprocessing. According to this embodiment, an information length occupied by target plane capability information of a UE in a registration request message can be reduced, and other target plane capability information of the UE is transmitted based on a requirement of the first target plane network function instance. Related steps are as follows:

Steps 1 to 3: When accessing a network, a UE transmits a registration request message to an AMF by using the access network, and the registration request message carries a part of terminal target plane capability information of the UE. Usually, the part of terminal target plane capability information is necessary information needed by the first target plane network function instance, and can support the first target plane network function instance in deciding whether more target plane information is needed. Therefore, the part may also be referred to as basic information or mandatory capability information. For example, the part of terminal target plane capability information may indicate whether the UE supports a target plane.

Step 4: The first target plane network function instance decides a selected UE based on an external data request and/or an internal function.

Step 5: The first target plane network function instance requests a part of terminal target plane capabilities of the selected UE from the AMF.

Step 6: The AMF transmits a part of terminal target plane capability information of the selected UE to the first target plane network function instance.

Step 7: The first target plane network function instance decides whether more terminal target plane capability information of the selected UE is needed based on a requirement. If needed, go to step 8 and step 9.

Step 8: The first target plane network function instance transmits a terminal target plane capability enquiry to the selected UE, and enquiry information needs to indicate specific target plane capability information that is needed, for example, all target plane capability information, or indicate a specific target plane capability information item by using a filter. If there is a connection between the UE and the first target plane network function instance, the first target plane network function instance may directly transmit the terminal target plane capability enquiry to the UE. If there is no connection between the two, the first target plane network function instance needs to transmit the terminal target plane capability enquiry through a core network device that establishes a connection to the UE, for example, an AMF.

Step 9: The UE reports the terminal target plane capability information of the UE based on an indication in request information.

Embodiment 3 of this application: a UE target plane capability reporting solution based on a radio access network procedure

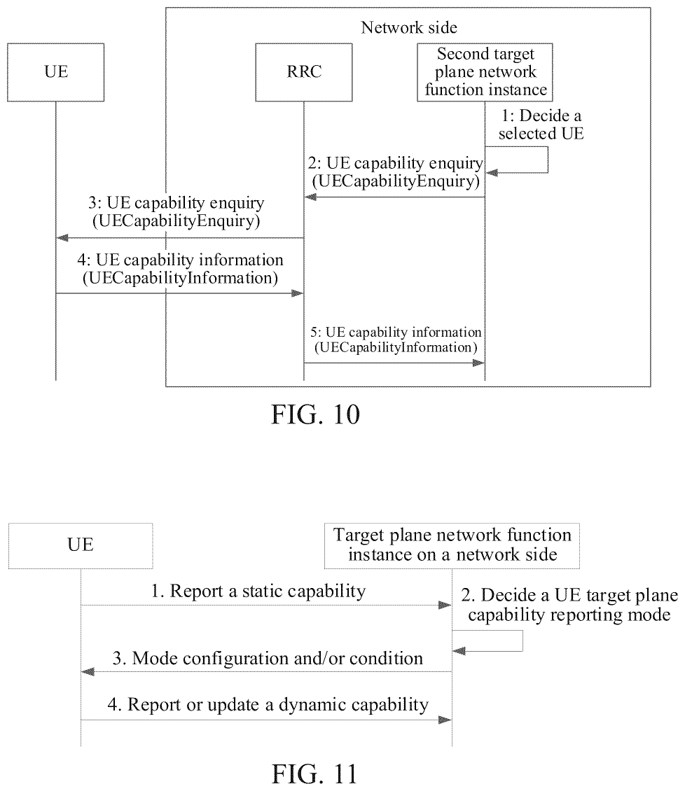

This embodiment of this application provides the UE target plane capability reporting solution based on the radio access network procedure. As shown in FIG. 10, a second target plane function is a network function of the radio access network for supporting any one or more of data collection, data distribution, data security, data privacy, data analysis, or data preprocessing. In this example, a target plane capability is an access stratum target plane capability, and may also be referred to as a name such as a capability of a radio access network data layer. Related steps are as follows:

Step 1: The second target plane network function instance decides, based on a received data request, and/or configuration information of a first target plane network function instance, and/or internal function information, a selected UE and whether needed target plane capability information of the UE needs to be requested. If needed, go to steps 2 to 5.

Step 2: The second target plane network function instance transmits a UE target plane capability request to a Radio Resource Control (RRC) function, to indicate the needed target plane capability information.

Step 3: The RRC function requests the needed capability information from the UE by using an extended UE capability enquiry (CapabilityEnquiry) message.

Step 4: The UE feeds back the target plane capability information of the UE based on request information.

Step 5: The RRC function transmits the received target plane capability information to the second target plane network function instance.

If there is a connection between the second target plane network function instance and the UE, interaction of the message may be directly performed between the UE and the second target plane network function instance without the RRC function.

Embodiment 4 of this application: a reporting solution for a static capability and a dynamic capability

As described in the foregoing technical solutions, in some implementations of this application, the reporting solution for the static capability and the dynamic capability when a UE supports the static capability and the dynamic capability is considered. For example, a target plane capability may be dynamically updated based on a communication load status of the UE. A target plane capability update condition may be one or more of the following.

(1) A level of a target plane capability of the terminal changes.

In some implementations, the target plane capability is defined into a plurality of levels based on a parameter and/or a value range of the target plane capability, and when the capability changes from a level to another level, an update is needed.

(2) A parameter and/or a value range of the target plane capability of the terminal that is configured by a network side meets a preset condition.

For example, the target plane capability is updated when a total buffer size (total buffer size) that is of the target plane and that is configured by the network side is less than A.

(3) A value range of a parameter associated with the target plane capability of the terminal changes.

An association design is performed based on one or more of UE-side parameters related to the target plane. For example, the target plane capability of the terminal is associated with a UE uplink/downlink RB quantity and/or a UE L2 buffer size, and the target plane capability update condition is met when the UE uplink/downlink RB quantity and/or the UE L2 buffer size is changed.

If the target plane capability update condition is met, at least one of the following update manners may be used.

(1) The terminal reports target plane capability information of the terminal.

For example, when the UE participates in a function procedure related to the target plane, and a capability change affects a current target plane function, active reporting by the UE helps a network adjust based on an update status more quickly.

(2) If the network requests the UE target plane capability information, the UE performs reporting.

For example, the UE does not participate in a functional procedure related to the target plane. Therefore, a capability change of the UE is not urgent, so that the UE may update a capability to the network when the network side has a requirement and makes a request.

(3) The terminal reports the parameter associated with the target plane capability of the terminal.

When the association design is performed by using one or more parameters related to the target plane capability, a current target plane capability may be mapped based on information reporting of the associated parameter. For example, a corresponding target plane capability is defined based on a combination range of the uplink RB quantity and/or the downlink RB quantity. In this case, the radio access network may learn the current target plane capability based on information about the uplink RB quantity and/or the downlink RB quantity.

When the UE supports both the dynamic capability and the static capability, and supports a plurality of update manners, and the update manners are configurable, as shown in FIG. 11, related steps of a capability reporting solution are briefly described as follows.

Step 1: A UE reports a static capability during accessing a network, and a target plane network function instance on a network side may be a first target plane network function instance and/or a second target plane network function instance.

Step 2: The target plane network function instance on the network side decides a UE target plane capability reporting or update manner based on the static capability and/or network-side UE context information.

Step 3: The target plane network function instance on the network side transmits a mode configuration and/or the target plane capability update condition, where the mode configuration may be configured as one or more of active reporting upon a change, network configuration condition reporting, and network enquiry reporting, and the target plane capability update condition is a condition of a target plane capability change of the UE, for example, a capability change based on a level, a key capability parameter, and/or a threshold.

Step 4: The UE and the target plane network function instance on the network side report or update a dynamic capability based on the information of step 3 and/or other information.

Embodiment 5 of this application: a terminal group target plane capability reporting solution

As described in the foregoing technical solutions, in some implementations, a terminal group target plane capability reporting or update solution when a target plane capability reported by a UE is greater than a target plane capability of another UE is considered. The foregoing case may occur in a terminal group formed by a plurality of terminals of a user, where one or more types of terminals such as a mobile phone, a wristband, and glasses may be included. The foregoing case may also occur in a terminal group formed by a plurality of terminals connected through a sidelink. The foregoing case may also occur in a terminal group formed by a plurality of terminals configured in a network, and the terminals in the terminal group may interact through a mobile access network base station, a core network, and/or the like. Related steps of a target plane capability reporting solution in the foregoing scenario are briefly described as follows.

Step 1: A UE reports a target plane capability during accessing a network. If at this time, the UE has formed a terminal group with another terminal, and a capability of the terminal group is reported by the UE, the UE indicates the capability as the capability of the terminal group during reporting the target plane capability. The corresponding capability may be the capability of the terminal group, and capability parameters do not indicate to which UE of the terminal group a specific capability parameter belongs. This case is applicable to a terminal group formed by a plurality of terminals of a user. The network does not need to learn capabilities of the terminals. The solution is simple. In addition, privacy of the user and cooperation in the terminal group are improved. In another option, the capability of the terminal group may be reported by using UEs as indexes. In this reporting manner, a network side may learn to which UE each capability parameter belongs. If the terminal group is configured by the network side, a precondition is that the UE receives a terminal group configuration of the network side, interacts with the UEs in the terminal group to form the capability of the terminal group, and then performs reporting.

Step 2: The network side decides, based on a static capability reported by the UE and/or network-side UE context information, a UE target plane capability reporting or update manner.

Step 3: The network side transmits a mode configuration and/or a condition, where the mode configuration may be configured as one or more of active reporting upon a change, network configuration condition reporting, and network enquiry reporting, and the condition is a condition of a target plane capability change of the UE, for example, a capability change based on a level, a key capability parameter and/or a threshold, a UE change of the terminal group.

Step 4: The UE and the network side report or update a dynamic capability based on the information of step 3 and/or other information. If the latter option is used in the UE capability reporting in step 1, in other words, the network side may learn which UE each capability parameter is provided by, a UE identifier and target plane capability change information may be reported during dynamic capability reporting or update. For example, when a UE A exits the terminal group, the network side may delete a capability provided by the corresponding UE A to perform update.

In the foregoing embodiments of this application, if the target plane dynamic capability of the terminal is jointly defined with a value or a value range of a key parameter of a user plane and/or a control plane of the terminal, a target plane network function instance (for example, a first target plane network function instance or a second target plane network function instance) may enquire, from another network function, the value of the key parameter of the user plane and/or the control plane jointly defined with the target plane dynamic capability, to obtain target plane capability information based on joint definition information. A joint definition manner may be that different values or value ranges of the key parameter of the user plane and/or the control plane are defined as different communication capability levels, and then target plane capability levels and the communication capability (the key parameter of the user plane and/or the control plane) levels have a mapping relationship. For example, based on information such as Physical Resource Block (PRB) utilization and uplink and downlink speeds, a terminal communication capability status is defined into three levels: a high level, a medium level, and a low level, which respectively correspond to three terminal target plane capabilities. An example is shown in the following table. The target plane network function instance enquires a current communication capability level of the terminal, to obtain a current target plane capability level of the terminal.

| Communication capability level | Target plane capability level |
|---|---|
| High | Low |
| Medium | Medium |
| Low | High |

The terminal target plane capability reporting method provided in embodiments of this application may be performed by a terminal target plane capability reporting apparatus. In embodiments of this application, that the terminal target plane capability reporting apparatus performs the terminal target plane capability reporting method is used as an example, to describe the terminal target plane capability reporting apparatus provided in embodiments of this application.

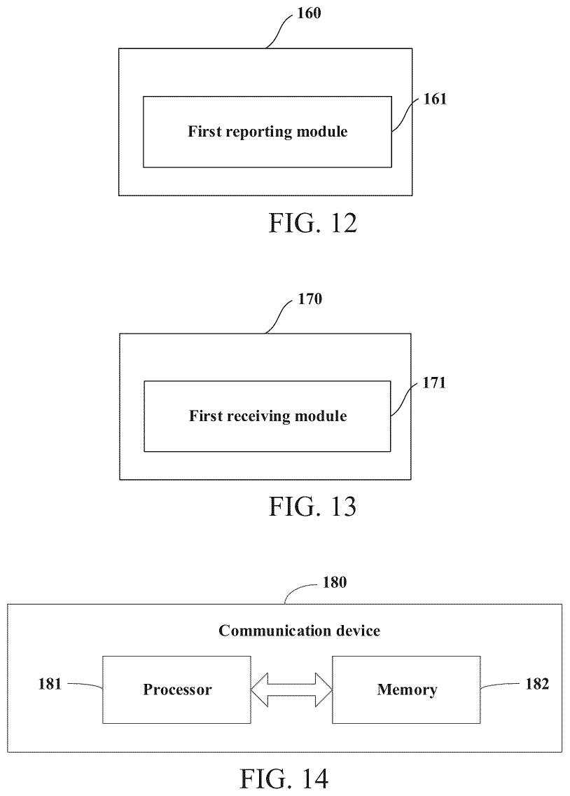

Refer to FIG. 12. An embodiment of this application further provides a terminal target plane capability reporting apparatus 160, including:

a first reporting module 161, configured to report target plane capability information of a terminal, where a target plane is a protocol function plane configured to support at least one of data collection, data distribution, data security, data privacy, data analysis, or data preprocessing.

In some implementations of this application, the terminal reports the target plane capability information to a network function, where the target plane is the protocol function plane configured to support at least one of the data collection, the data distribution, the data security, the data privacy, the data analysis, or the data preprocessing, to implement data collection and use for end-to-end network functions.

In some implementations, the target plane capability information includes at least one of the following:
information indicating whether the terminal supports the target plane;
information indicating that a target plane capability is a capability of a single terminal or a terminal group, where the terminal group includes at least two terminals;
information indicating that the target plane capability is a static capability or a dynamic capability;
a supported target plane capability reporting manner;
information indicating whether a target plane capability reporting manner configured by a network side is supported;
a supported target plane data reporting mode;
a data type supported by the target plane;
a supported transmission direction of the target plane;
a supported maximum data uplink rate of the target plane;
a supported maximum data downlink rate of the target plane;
a total buffer size of the target plane;
a supported target plane function;
a supported maximum quantity of data collection items;
a supported ID sequence number size;
a supported minimum time granularity of data collection;
a supported minimum time granularity of data reporting;
a supported maximum length of a single target plane packet;
information indicating whether the terminal supports data collection and reporting in a connected state;
information indicating whether the terminal supports data collection and reporting in an idle state and/or an inactive state; or
information indicating whether the terminal supports continuity of a target plane across states.

In some implementations, the first reporting module 161 is configured to report the target plane capability information of the terminal to a core network device.

In some implementations, the first reporting module 161 is configured to transmit a registration request message to the core network device when the terminal accesses a network, where the registration request message carries the target plane capability information of the terminal.

In some implementations, the first reporting module 161 is configured to report all target plane capability information of the terminal to the core network device.

In some implementations, the first reporting module 161 is configured to report a part of target plane capability information of the terminal to the core network device.

In some implementations, the terminal target plane capability reporting apparatus 160 further includes:
a first receiving module, configured to receive target plane capability enquiry information transmitted by a first target plane network function instance, where the enquiry information indicates target plane capability information that needs to be enquired, and the first target plane network function instance implements a network function of the core network device for supporting at least one of the data collection, the data distribution, the data security, the data privacy, the data analysis, or the data preprocessing.

The first reporting module 161 is configured to report the target plane capability information to the first target plane network function instance based on the target plane capability information that needs to be enquired.

In some implementations, the first reporting module 161 is configured to report the target plane capability information of the terminal to a radio access network device.

In some implementations, the terminal target plane capability reporting apparatus 160 further includes:
a second receiving module, configured to receive target plane capability enquiry information transmitted by a second target plane network function instance, where the enquiry information indicates target plane capability information that needs to be enquired, and the second target plane network function instance implements a network function of the radio access network device for supporting at least one of the data collection, the data distribution, the data security, the data privacy, the data analysis, or the data preprocessing.

In some implementations, the first reporting module 161 is configured to report the target plane capability information to the second target plane network function instance based on the target plane capability information that needs to be enquired.

In some implementations, the target plane capability enquiry information is carried in a terminal capability enquiry message.

In some implementations, the first reporting module 161 is configured to report the target plane capability information of the terminal if a target plane capability update condition is met, where the target plane capability update condition includes at least one of the following:

A level of a target plane capability of the terminal changes.

A parameter and/or a value range of the target plane capability of the terminal that is configured by a network side meets a preset condition.

A value range of a parameter associated with the target plane capability of the terminal changes.

In some implementations, the reporting the target plane capability information of the terminal if the target plane capability update condition is met includes at least one of the following:
reporting the target plane capability information of the terminal if the target plane capability update condition is met;
reporting the target plane capability information of the terminal if the target plane capability update condition is met and target plane capability enquiry information transmitted by the network side is received; or
reporting the parameter associated with the target plane capability of the terminal if the target plane capability update condition is met.

In some implementations, the first reporting module 161 is configured to report a target plane static capability of the terminal.

The terminal target plane capability reporting apparatus 160 further includes:
a third receiving module, configured to receive a target plane capability reporting manner configuration and/or a target plane capability update condition transmitted by a network side.

In some implementations, the first reporting module 161 is configured to report a target plane dynamic capability of the terminal based on the target plane capability reporting manner configuration and/or the target plane capability update condition.

In some implementations, the target plane capability information includes:
information indicating that a target plane capability is a capability of a terminal group.

In some implementations, the first reporting module 161 is configured to report the target plane capability information of the terminal if a target plane capability update condition is met, where the target plane capability update condition includes at least one of the following:

A level of a target plane capability of a terminal in the terminal group changes.

A parameter and/or a value range of the target plane capability of the terminal in the terminal group that is configured by a network side meets a preset condition.

A value range of a parameter associated with the target plane capability of the terminal in the terminal group changes.

The terminal in the terminal group changes.

In some implementations, the target plane capability information includes: an identifier of each terminal in the terminal group, and the identifier of the terminal is associated with the target plane capability information belonging to the terminal.

The target plane capability reporting apparatus in some implementations of this application may be an electronic device, for example, an electronic device having an operating system, or may be a component in the electronic device, for example, an integrated circuit or a chip. The electronic device may be a terminal, or may be another device than the terminal. For example, the terminal may include, but is not limited to, the types of the terminal 11 listed above, and the another device may be a server, a Network Attached Storage (NAS), or the like. This is not specifically limited in this embodiment of this application.

The terminal target plane capability reporting apparatus provided in some implementations of this application can implement processes implemented in the method embodiment of FIG. 6, and same technical effects can be achieved. To avoid repetition, details are not described herein again.

The terminal target plane capability obtaining method provided in embodiments of this application may be performed by a terminal target plane capability obtaining apparatus. In embodiments of this application, that the terminal target plane capability obtaining apparatus performs the terminal target plane capability obtaining method is used as an example, to describe the terminal target plane capability obtaining apparatus provided in embodiments of this application.

Refer to FIG. 13. An embodiment of this application further provides a terminal target plane capability obtaining apparatus 170, including:

a first receiving module 171, configured to receive target plane capability information of a terminal, where a target plane is a protocol function plane configured to support at least one of data collection, data distribution, data security, data privacy, data analysis, or data preprocessing.

In some implementations, the target plane capability information includes at least one of the following:
information indicating whether the terminal supports the target plane;
information indicating that a target plane capability is a capability of a single terminal or a terminal group, where the terminal group includes at least two terminals;
information indicating that the target plane capability is a static capability or a dynamic capability;
a supported target plane capability reporting manner;
information indicating whether a target plane capability reporting manner configured by a network side is supported;
a supported target plane data reporting mode;
a data type supported by the target plane;
a supported transmission direction of the target plane;
a supported maximum data uplink rate of the target plane;
a supported maximum data downlink rate of the target plane;
a total buffer size of the target plane;
a supported target plane function;
a supported maximum quantity of data collection items;
a supported ID sequence number size;
a supported minimum time granularity of data collection;
a supported minimum time granularity of data reporting;
a supported maximum length of a single target plane packet;
information indicating whether the terminal supports data collection and reporting in a connected state;
information indicating whether the terminal supports data collection and reporting in an idle state and/or an inactive state; or
information indicating whether the terminal supports continuity of a target plane across states.

In some implementations, the terminal target plane capability obtaining apparatus 170 is a core network function instance or a radio access network function instance.

In some implementations, the terminal target plane capability obtaining apparatus 170 is the core network function instance, and target plane capability information received by the core network function instance is a part of target plane capability information of the terminal. The terminal target plane capability obtaining apparatus 170 further includes:

a first transmit module, configured to transmit target plane capability enquiry information, where the enquiry information indicates target plane capability information that needs to be enquired.

The first receiving module 171 is configured to receive the target plane capability information reported by the terminal based on the target plane capability information that needs to be enquired.

In some implementations, the terminal target plane capability obtaining apparatus 170 is the radio access network function instance, and the terminal target plane capability obtaining apparatus 170 further includes:
a second transmit module, configured to transmit target plane capability enquiry information, where the enquiry information indicates target plane capability information that needs to be enquired.

In some implementations, the terminal target plane capability obtaining apparatus 170 further includes:
a second receiving module, configured to receive a target plane static capability of the terminal; and
a third transmit module, configured to transmit a target plane capability reporting manner configuration and/or a target plane capability update condition based on the target plane static capability of the terminal.

The first receiving module 171 is configured to receive a target plane dynamic capability reported by the terminal based on the target plane capability reporting manner configuration and/or the target plane capability update condition.

The terminal target plane capability obtaining apparatus provided in some implementations of this application can implement processes implemented in the method embodiment of FIG. 7, and same technical effects can be achieved. To avoid repetition, details are not described herein again.

In some implementations, as shown in FIG. 14, an embodiment of this application further provides a communication device 180, including a processor 181 and a memory 182. The memory 182 stores a program or instructions executable on the processor 181. For example, when the communication device 180 is a terminal, the program or the instructions, when executed by the processor 181, implement steps of the foregoing terminal target plane capability reporting method embodiment, and same technical effects can be achieved. When the communication device 180 is a network device, the program or the instructions, when executed by the processor 181, implement steps of the foregoing terminal target plane capability obtaining method embodiment, and same technical effects can be achieved. To avoid repetition, details are not described herein again.

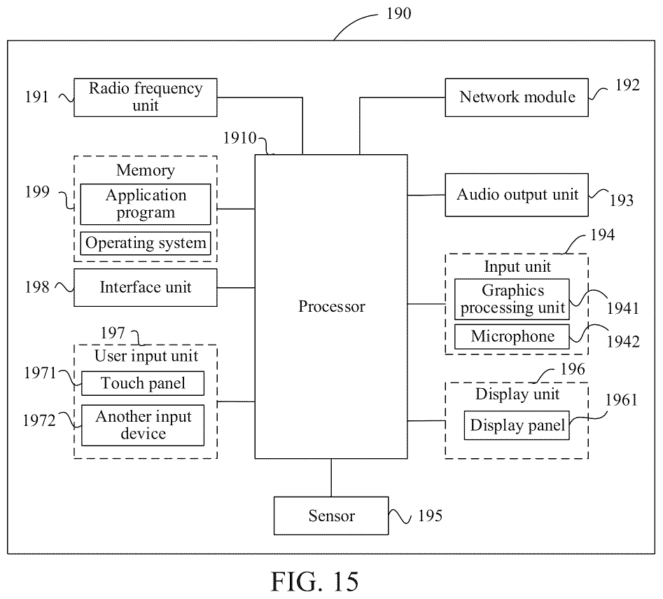

An embodiment of this application further provides a terminal, including a processor and a communication interface. The communication interface is configured to report target plane capability information of the terminal, and a target plane is a protocol function plane configured to support at least one of data collection, data distribution, data security, data privacy, data analysis, or data preprocessing. The terminal embodiment corresponds to the foregoing terminal-side method embodiment. Each implementation process and implementation of the foregoing method embodiment may be applied to the terminal embodiment, and same technical effects can be achieved. Specifically, FIG. 15 is a schematic diagram of a hardware structure of a terminal according to an embodiment of this application.

The terminal 190 includes, but is not limited to: at least a part of components including a radio frequency unit 191, a network module 192, an audio output unit 193, an input unit 194, a sensor 195, a display unit 196, a user input unit 197, an interface unit 198, a memory 199, a processor 1910, and the like.

A person skilled in the art may understand that the terminal 190 may further include a power supply (for example, a battery) for supplying power to the components. The power supply may be logically connected to the processor 1910 by using a power management system, to implement functions such as charging, discharging, and power consumption management by using the power management system. The terminal structure shown in FIG. 15 does not constitute a limitation on the terminal, and the terminal may include more or fewer components than shown, or combine some components, or have different component arrangements. Details are not described herein again.

It should be understood that, in some implementations of this application, the input unit 194 may include a Graphics Processing Unit (GPU) 1941 and a microphone 1942. The graphics processing unit 1941 performs processing on image data of a static picture or a video that is obtained by an image capturing apparatus (for example, a camera) in a video capturing mode or an image capturing mode. The display unit 196 may include a display panel 1961. The display panel 1961 may be configured in a form of a liquid crystal display, an organic light-emitting diode, or the like. The user input unit 197 includes at least one of a touch panel 1971 and another input device 1972. The touch panel 1971 is also referred to as a touch screen. The touch panel 1971 may include two parts: a touch detection apparatus and a touch controller. The another input device 1972 may include, but not limited to, a physical keyboard, a functional key (for example, a volume control key or a switch key), a track ball, a mouse, and a joystick. Details are not described herein again.

In some implementations of this application, after receiving downlink data from a network-side device, the radio frequency unit 191 may transmit the downlink data to the processor 1910 for processing. In addition, the radio frequency unit 191 may transmit uplink data to the network-side device. Usually, the radio frequency unit 191 includes, but is not limited to, an antenna, an amplifier, a transceiver, a coupler, a low noise amplifier, a duplexer, and the like.

The memory 199 may be configured to store a software program or instructions and various data. The memory 199 may mainly include a first storage area for storing the program or the instructions and a second storage area for storing the data. The first storage area may store an operating system, an application program or instructions needed by at least one function (for example, a sound playback function and an image display function), and the like.

The memory 199 may include a volatile memory or a non-volatile memory, or may include both the volatile memory and the non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DR RAM). The memory 199 in some implementations of this application includes, but is not limited to, these memories and any other appropriate types of memories.

The processor 1910 may include one or more processing units. In some implementations, the processor 1910 integrates an application processor and a modem processor. The application processor mainly processes an operation related to an operating system, a user interface, an application program, and the like. The modem processor mainly processes a wireless communication signal, such as a baseband processor. It may be understood that the modem processor may or may not be integrated into the processor 1910.

The radio frequency unit 191 is configured to report target plane capability information of the terminal, where a target plane is a protocol function plane configured to support at least one of data collection, data distribution, data security, data privacy, data analysis, or data preprocessing.

In some implementations of this application, the terminal reports the target plane capability information to a network function, where the target plane is the protocol function plane configured to support at least one of the data collection, the data distribution, the data security, the data privacy, the data analysis, or the data preprocessing, to implement data collection and use for end-to-end network functions.

In some implementations, the target plane capability information includes at least one of the following:
information indicating whether the terminal supports the target plane;
information indicating that a target plane capability is a capability of a single terminal or a terminal group, where the terminal group includes at least two terminals;
information indicating that the target plane capability is a static capability or a dynamic capability;
a supported target plane capability reporting manner;
information indicating whether a target plane capability reporting manner configured by a network side is supported;
a supported target plane data reporting mode;
a data type supported by the target plane;
a supported transmission direction of the target plane;
a supported maximum data uplink rate of the target plane;
a supported maximum data downlink rate of the target plane;
a total buffer size of the target plane;
a supported target plane function;
a supported maximum quantity of data collection items;
a supported ID sequence number size;
a supported minimum time granularity of data collection;
a supported minimum time granularity of data reporting;
a supported maximum length of a single target plane packet;
information indicating whether the terminal supports data collection and reporting in a connected state;
information indicating whether the terminal supports data collection and reporting in an idle state and/or an inactive state; or
information indicating whether the terminal supports continuity of a target plane across states.

In some implementations, the radio frequency unit 191 is configured to report the target plane capability information of the terminal to a core network device.

In some implementations, the radio frequency unit 191 is configured to transmit a registration request message to the core network device when the terminal accesses a network, where the registration request message carries the target plane capability information of the terminal.

In some implementations, the radio frequency unit 191 is configured to report all target plane capability information of the terminal to the core network device.

In some implementations, the radio frequency unit 191 is configured to report a part of target plane capability information of the terminal to the core network device.

In some implementations, the radio frequency unit 191 is further configured to receive target plane capability enquiry information transmitted by a first target plane network function instance, where the enquiry information indicates target plane capability information that needs to be enquired, and the first target plane network function instance implements a network function of the core network device for supporting at least one of the data collection, the data distribution, the data security, the data privacy, the data analysis, or the data preprocessing.

The radio frequency unit 191 is configured to report the target plane capability information to the first target plane network function instance based on the target plane capability information that needs to be enquired.

In some implementations, the radio frequency unit 191 is configured to report the target plane capability information of the terminal to a radio access network device.

In some implementations, the radio frequency unit 191 is further configured to receive target plane capability enquiry information transmitted by a second target plane network function instance, where the enquiry information indicates target plane capability information that needs to be enquired, and the second target plane network function instance implements a network function of the radio access network device for supporting at least one of the data collection, the data distribution, the data security, the data privacy, the data analysis, or the data preprocessing.

In some implementations, the radio frequency unit 191 is configured to report the target plane capability information to the second target plane network function instance based on the target plane capability information that needs to be enquired.

In some implementations, the target plane capability enquiry information is carried in a terminal capability enquiry message.

In some implementations, the radio frequency unit 191 is configured to report the target plane capability information of the terminal if a target plane capability update condition is met, where the target plane capability update condition includes at least one of the following:

A level of a target plane capability of the terminal changes.

A parameter and/or a value range of the target plane capability of the terminal that is configured by a network side meets a preset condition.

A value range of a parameter associated with the target plane capability of the terminal changes.

In some implementations, the reporting the target plane capability information of the terminal if the target plane capability update condition is met includes at least one of the following:
reporting the target plane capability information of the terminal if the target plane capability update condition is met;
reporting the target plane capability information of the terminal if the target plane capability update condition is met and target plane capability enquiry information transmitted by the network side is received; or
reporting the parameter associated with the target plane capability of the terminal if the target plane capability update condition is met.

In some implementations, the radio frequency unit 191 is configured to report a target plane static capability of the terminal; and
the radio frequency unit 191 is further configured to receive a target plane capability reporting manner configuration and/or a target plane capability update condition transmitted by a network side;

In some implementations, the radio frequency unit 191 is configured to report a target plane dynamic capability of the terminal based on the target plane capability reporting manner configuration and/or the target plane capability update condition.

In some implementations, the target plane capability information includes: information indicating that a target plane capability is a capability of a terminal group.

In some implementations, the radio frequency unit 191 is configured to report the target plane capability information of the terminal if a target plane capability update condition is met, where the target plane capability update condition includes at least one of the following:

A level of a target plane capability of a terminal in the terminal group changes.

A parameter and/or a value range of the target plane capability of the terminal in the terminal group that is configured by a network side meets a preset condition.

A value range of a parameter associated with the target plane capability of the terminal in the terminal group changes.

The terminal in the terminal group changes.

In some implementations, the target plane capability information includes: an identifier of each terminal in the terminal group, and the identifier of the terminal is associated with the target plane capability information belonging to the terminal.

An embodiment of this application further provides a network device, including a processor and a communication interface. The communication interface is configured to receive target plane capability information of a terminal, and a target plane is a protocol function plane configured to support at least one of data collection, data distribution, data security, data privacy, data analysis, or data preprocessing. The network device embodiment corresponds to the foregoing network device method embodiment. Each implementation process and implementation of the foregoing method embodiment may be applied to the network device embodiment, and same technical effects can be achieved.

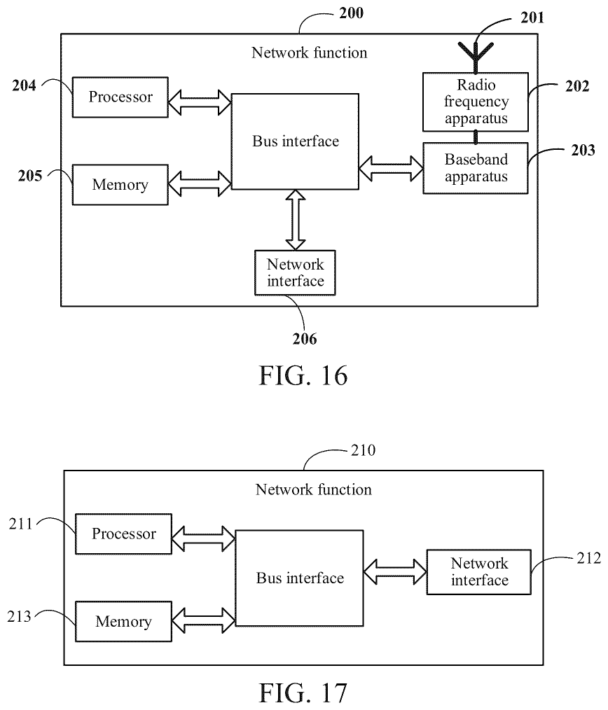

An embodiment of this application further provides a network device. As shown in FIG. 16, the network device 200 includes: an antenna 201, a radio frequency apparatus 202, a baseband apparatus 203, a processor 204, and a memory 205. The antenna 201 is connected to the radio frequency apparatus 202. In an uplink direction, the radio frequency apparatus 202 receives information through the antenna 201, and transmits the received information to the baseband apparatus 203 for processing. In a downlink direction, the baseband apparatus 203 processes to-be-transmitted information and transmits processed information to the radio frequency apparatus 202. The radio frequency apparatus 202 processes received information and transmits processed information through the antenna 201.

The method performed by the network device in the foregoing embodiments may be implemented in the baseband apparatus 203, and the baseband apparatus 203 includes a baseband processor.

The baseband apparatus 203 may include, for example, at least one baseband board, and a plurality of chips are disposed on the baseband board. As shown in FIG. 16, one chip is, for example, the baseband processor, and is connected to the memory 205 through a bus interface, to invoke a program in the memory 205, so as to perform a network device operation shown in the foregoing method embodiments.

The network device may further include a network interface 206. For example, the interface is a Common Public Radio Interface (CPRI).

The network device 200 in some implementations of this application further includes instructions or a program that is stored in the memory 205 and executable on the processor 204. The processor 204 invokes the instructions or the program in the memory 205 to perform the method performed by the modules shown in FIG. 13, and same technical effects are achieved. To avoid repetition, details are not described herein again.

An embodiment of this application further provides a network device. As shown in FIG. 17, the network device 210 includes: a processor 211, a network interface 212, and a memory 213. The network interface 212 is, for example, a CPRI. The network device 210 in some implementations of this application further includes instructions or a program that is stored in the memory 213 and executable on the processor 211. The processor 211 invokes the instructions or the program in the memory 213 to perform the method performed by the modules shown in FIG. 13, and same technical effects are achieved. To avoid repetition, details are not described herein again.

An embodiment of this application further provides a readable storage medium. The readable storage medium stores a program or instructions. The program or the instructions, when executed by a processor, implement processes in the foregoing terminal target plane capability reporting method embodiment or the foregoing terminal target plane capability obtaining method embodiment, and same technical effects can be achieved. To avoid repetition, details are not described herein again.

The processor is the processor of the terminal in the foregoing embodiment. The readable storage medium includes a computer-readable storage medium, such as a computer Read-Only Memory (ROM), a Random Access Memory (RAM), a magnetic disk, or an optical disk.

An embodiment of this application further provides a chip. The chip includes a processor and a communication interface. The communication interface is coupled to the processor, the processor is configured to run a program or instructions, to implement processes in the foregoing terminal target plane capability reporting method embodiment or the foregoing terminal target plane capability obtaining method embodiment, and same technical effects can be achieved. To avoid repetition, details are not described herein again.

It should be understood that the chip described in some implementations of this application may also be referred to as a system-level chip, a system chip, a chip system, a system-on-a-chip, or the like.

An embodiment of this application further provides a computer program/program product. The computer program/program product is stored in a storage medium. The computer program/program product is executed by at least one processor, to implement processes of the foregoing terminal target plane capability reporting method embodiment or the foregoing terminal target plane capability obtaining method embodiment, and same technical effects can be achieved. To avoid repetition, details are not described herein again.

An embodiment of this application further provides a communication system, including: a terminal and a network device, where the terminal may be configured to perform steps of the terminal target plane capability reporting method as described above, and the network device may be configured to perform steps of the terminal target plane capability obtaining method as described above.

It should be noted that the terms “include,” “comprise,” or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, an element limited by the sentence “including one . . . ” does not exclude that there is still another same element in processes, methods, objects, or apparatuses including the element. In addition, it should be noted that the scope of the methods and apparatuses in implementations of this application is not limited to performing functions in an order shown or discussed, but may further include performing functions in a substantially simultaneous manner or in a reverse order based on related functions. For example, the described methods may be performed in an order different from the described order, and various steps may further be added, omitted, or combined. In addition, features described in combination with some examples may be combined in another example.

Based on the descriptions in the foregoing implementations, a person skilled in the art may learn that the method according to the foregoing embodiment may be implemented in a manner of software and a necessary universal hardware platform or certainly by using hardware. Based on such an understanding, the technical solutions of this application essentially, or the part contributing to the prior art, may be presented in a form of a computer software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in embodiments of this application.

Embodiments of this application are described above with reference to the accompanying drawings. However, this application is not limited to the foregoing specific implementations, and the foregoing specific implementations are only by way of example, and not limitation. A person of ordinary skill in the art may make various variations under the teaching of this application without departing from the spirit of this application and the protection scope of the claims, and such variations shall all fall within the protection scope of this application.

What is claimed is:

1. A terminal target plane capability reporting method, performed by a terminal, comprising:
reporting target plane capability information of the terminal, wherein a target plane is a protocol function plane configured to support at least one of data collection, data distribution, data security, data privacy, data analysis, or data preprocessing.

2. The method according to claim 1, wherein the target plane capability information comprises at least one of the following:
information indicating whether the terminal supports the target plane;
information indicating that a target plane capability is a capability of a single terminal or a terminal group, wherein the terminal group comprises at least two terminals;
information indicating that the target plane capability is a static capability or a dynamic capability;
a supported target plane capability reporting manner;
information indicating whether a target plane capability reporting manner configured by a network side is supported;
a supported target plane data reporting mode;
a data type supported by the target plane;
a supported transmission direction of the target plane;
a supported maximum data uplink rate of the target plane;
a supported maximum data downlink rate of the target plane;
a total buffer size of the target plane;
a supported target plane function;
a supported maximum quantity of data collection items;
a supported ID sequence number size;
a supported minimum time granularity of data collection;
a supported minimum time granularity of data reporting;
a supported maximum length of a single target plane packet;
information indicating whether the terminal supports data collection and reporting in a connected state;
information indicating whether the terminal supports data collection and reporting in an idle state or an inactive state; or
information indicating whether the terminal supports continuity of a target plane across states.

3. The method according to claim 1, wherein the reporting target plane capability information of the terminal comprises:
reporting the target plane capability information of the terminal to a core network device.

4. The method according to claim 3, wherein the reporting the target plane capability information of the terminal to a core network device comprises:
transmitting a registration request message to the core network device when accessing a network, wherein the registration request message carries the target plane capability information of the terminal;
reporting all target plane capability information of the terminal to the core network device;
reporting a part of target plane capability information of the terminal to the core network device; or
receiving target plane capability enquiry information transmitted by a first target plane network function instance, wherein the enquiry information indicates target plane capability information that needs to be enquired, and the first target plane network function instance implements a network function of the core network device for supporting at least one of the data collection, the data distribution, the data security, the data privacy, the data analysis, or the data preprocessing, and
reporting the target plane capability information to the first target plane network function instance based on the target plane capability information that needs to be enquired.

5. The method according to claim 1, wherein the reporting target plane capability information of the terminal comprises:
reporting the target plane capability information of the terminal to a radio access network device.

6. The method according to claim 5, wherein before the reporting the target plane capability information of the terminal to a radio access network device, the method further comprises:
receiving target plane capability enquiry information transmitted by a second target plane network function instance, wherein the enquiry information indicates target plane capability information that needs to be enquired, and the second target plane network function instance implements a network function of the radio access network device for supporting at least one of the data collection, the data distribution, the data security, the data privacy, the data analysis, or the data preprocessing; and
the reporting the target plane capability information of the terminal to a radio access network device comprises: reporting the target plane capability information to the second target plane network function instance based on the target plane capability information that needs to be enquired.

7. The method according to claim 6, wherein the target plane capability enquiry information is carried in a terminal capability enquiry message.

8. The method according to claim 1, wherein the reporting target plane capability information of the terminal comprises:
reporting the target plane capability information of the terminal when a target plane capability update condition is met, wherein the target plane capability update condition comprises at least one of the following:
a level of a target plane capability of the terminal changes;
a parameter or a value range of the target plane capability of the terminal that is configured by a network side meets a preset condition; or
a value range of a parameter associated with the target plane capability of the terminal changes,
wherein the reporting the target plane capability information of the terminal when a target plane capability update condition is met comprises at least one of the following:
reporting the target plane capability information of the terminal when the target plane capability update condition is met;
reporting the target plane capability information of the terminal when the target plane capability update condition is met and target plane capability enquiry information transmitted by the network side is received; or
reporting the parameter associated with the target plane capability of the terminal when the target plane capability update condition is met.

9. The method according to claim 1, wherein the reporting target plane capability information of the terminal comprises:
reporting a target plane static capability of the terminal;
receiving a target plane capability reporting manner configuration or a target plane capability update condition transmitted by a network side; and
reporting a target plane dynamic capability of the terminal based on the target plane capability reporting manner configuration or the target plane capability update condition.

10. The method according to claim 1, wherein the target plane capability information comprises: information indicating that a target plane capability is a capability of a terminal group.

11. The method according to claim 10, wherein the reporting target plane capability information of the terminal comprises:
reporting the target plane capability information of the terminal when a target plane capability update condition is met, wherein the target plane capability update condition comprises at least one of the following:
a level of a target plane capability of the terminal in the terminal group changes;
a parameter or a value range of the target plane capability of the terminal in the terminal group that is configured by a network side meets a preset condition;
a value range of a parameter associated with the target plane capability of the terminal in the terminal group changes; or
the terminal in the terminal group changes.

12. The method according to claim 10, wherein the target plane capability information comprises: an identifier of each terminal in the terminal group, and the identifier of the terminal is associated with the target plane capability information belonging to the terminal.

13. A terminal target plane capability obtaining method, performed by a network function instance, comprising:
receiving target plane capability information of a terminal, wherein a target plane is a protocol function plane configured to support at least one of data collection, data distribution, data security, data privacy, data analysis, or data preprocessing.

14. The method according to claim 13, wherein the target plane capability information comprises at least one of the following:
information indicating whether the terminal supports the target plane;
information indicating that a target plane capability is a capability of a single terminal or a terminal group, wherein the terminal group comprises at least two terminals;
information indicating that the target plane capability is a static capability or a dynamic capability;
a supported target plane capability reporting manner;
information indicating whether a target plane capability reporting manner configured by a network side is supported;
a supported target plane data reporting mode;
a data type supported by the target plane;
a supported transmission direction of the target plane;
a supported maximum data uplink rate of the target plane;
a supported maximum data downlink rate of the target plane;
a total buffer size of the target plane;
a supported target plane function;
a supported maximum quantity of data collection items;
a supported ID sequence number size;
a supported minimum time granularity of data collection;
a supported minimum time granularity of data reporting;
a supported maximum length of a single target plane packet;
information indicating whether the terminal supports data collection and reporting in a connected state;
information indicating whether the terminal supports data collection and reporting in an idle state or an inactive state; or
information indicating whether the terminal supports continuity of a target plane across states.

15. The method according to claim 13, wherein the network function instance is the core network function instance, and the target plane capability information received by the core network function instance is a part of target plane capability information of the terminal; wherein before the receiving target plane capability information of a terminal, the method further comprises:
transmitting target plane capability enquiry information, wherein the enquiry information indicates target plane capability information that needs to be enquired; and
receiving the target plane capability information reported by the terminal based on the target plane capability information that needs to be enquired.

16. The method according to claim 13, wherein the network function instance is a radio access network function instance, and before the receiving target plane capability information of a terminal, the method further comprises:
transmitting, by the radio access network function instance, target plane capability enquiry information, wherein the enquiry information indicates target plane capability information that needs to be enquired.

17. The method according to claim 14, wherein the receiving target plane capability information of a terminal comprises:
receiving a target plane static capability of the terminal;
transmitting a target plane capability reporting manner configuration or a target plane capability update condition based on the target plane static capability of the terminal; and
receiving a target plane dynamic capability reported by the terminal based on the target plane capability reporting manner configuration or the target plane capability update condition.

18. A terminal, comprising:
a memory storing computer-readable instructions; and
a processor coupled to the memory and configured to execute the computer-readable instructions, wherein the computer-readable instructions, when executed by the processor, cause the processor to perform operations comprising:
reporting target plane capability information of the terminal, wherein a target plane is a protocol function plane configured to support at least one of data collection, data distribution, data security, data privacy, data analysis, or data preprocessing.

19. A network device, comprising:
a memory storing computer-readable instructions; and
a processor coupled to the memory and configured to execute the computer-readable instructions, wherein the computer-readable instructions, when executed by the processor, cause the processor to perform the terminal target plane capability obtaining method according to claim 13.

20. A non-transitory computer-readable medium storing instructions that, when executed by a processor, cause the processor to perform the terminal target plane capability obtaining method according to claim 1.
